(19) United States
(12) Patent Application Publication
(10) Pub. No.: US 2026/0205322 A1
(43) Pub. Date: Jul. 16, 2026

(54) SELECTIVELY FRAGMENTING PACKETS PRIOR TO TUNNEL ENCAPSULATION

(71) Applicant: Ruckus IP Holdings LLC, Claremont, NC (US)

(72) Inventors: Rajiv Shrirang Joshi, Cupertino, CA (US); Sridhar Malarouthu, Pleasanton, CA (US); Gefan Zhang, Sunnyvale, CA (US); Gajendra Shukla, Sunnyvale, CA (US); Rakesh Hansalia, Sunnyvale, CA (US)

(73) Assignee: Ruckus IP Holdings LLC, Claremont, NC (US)

(21) Appl. No.: 19/446,650

(22) Filed: Jan. 12, 2026

Related U.S. Application Data
(60) Provisional application No. 63/746,251, filed on Jan. 16, 2025.

(51) Int. Cl. H04L 12/46

(52) U.S. Cl. CPC H04L 12/4633; H04L 12/4641

(57) ABSTRACT

An electronic device (such as an access point) that selectively fragments a packet is described. This electronic device includes an interface circuit that communicates with a second electronic device, where the electronic device and the second electronic device are tunnel endpoints. During operation, the electronic device may receive a packet (e.g., from user equipment or a client) having a payload size. When the payload size exceeds a predefined value, the electronic device may fragment the packet into two or more fragments, where a given fragment has a payload size that is less than the predefined value. Then, the electronic device may encapsulate the two or more fragments using VxLAN tunnel encapsulation, where the VxLAN tunnel encapsulation adds VxLAN tunnel headers to the two or more fragments. Next, the electronic device may provide, addressed to the second electronic device, the two or more tunnel encapsulated fragments.

### CROSS REFERENCE TO RELATED APPLICATION

This application claims priority under 35 U.S.C. 119(e) to U.S. Provisional Application Ser. No. 63/746,251, “Selectively Fragmenting Packets Prior to Tunnel Encapsulation,” filed on Jan. 16, 2025, the entirety of which is herein incorporated by reference.

### FIELD

The described embodiments relate to techniques for indicating the wireless capability of an electronic device (such as a station or client) to a computer network device (such as an access point).

### BACKGROUND

Many electronic devices are capable of wirelessly communicating with other electronic devices. Notably, these electronic devices can include a networking subsystem that implements a network interface for: a cellular network (UMTS, LTE, 5G Core or 5GC, etc.), a wireless local area network (e.g., a wireless network such as described in the Institute of Electrical and Electronics Engineers (IEEE) 802.11 standard or Bluetooth™ from the Bluetooth Special Interest Group of Kirkland, Washington), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points or APs (which are sometimes referred to as basic service sets or BSSs) that communicate wirelessly with each other and with other electronic devices using Wi-Fi, and that provide access to another network (such as the Internet) via IEEE 802.3 (which is sometimes referred to as ‘Ethernet’).

In many networks, tunnels (such as ‘Virtual eXtensible Local-Area Network or VxLAN’) are established between tunnel endpoints (which are sometimes referred to as ‘VxLAN tunnel endpoints’), such as an access point and another electronic device (which is sometimes referred to as a ‘Smart Edge device’, such as ‘Ruckus Edge’ from CommScope, Inc. of Claremont, North Carolina). (Note that, from the perspective an access point or a switch, a Smart Edge device is a device sitting at the network edge that acts as tunnel end point terminating a VxLAN tunnel from the access point or the switch.) The VxLAN protocol encapsulation typically adds an overhead of 50 B per packet, making the maximum size of an encapsulated Internet Protocol version 4 (IPv4) packet 1,550 B. However, the standard IP maximum transmission unit (MTU) of most interfaces (such as Ethernet or a Wi-Fi interface) in the network path between an access point and Smart Edge is 1,500 B. This may cause network distribution devices (such as like Layer 3 or L3 switches/routers) to fragment the encapsulated packet (e.g., the outer IP packet) before routing it to the final destination (such as an access point or a Smart Edge device, depending on the direction of the packet).

In some networks, it is also possible that the IP MTU of the network path between an access point and a Smart Edge device (and vice versa) may be lesser than 1,500 B (e.g., 1,200 B). This situation may also cause the network equipment to fragment the outer packet (e.g., a VxLAN encapsulated packet).

However, the VxLAN Request for Comments (RFC) (from the Internet Engineering Task Force of Fremont, California) does not permit fragmentation of encapsulated packets. Instead, to avoid fragmentation by network equipment, it recommends, increasing the IP MTU of all the electronic devices along the network path (or the path MTU) between the tunnel end points (such as an access point and a Smart Edge device) to 1,550 B.

This recommendation to increase the path MTU to 1550 B may not be possible or may be difficult to do in some customer deployments. For example, increasing the path MTU may require MTU changes on all of the distribution network between an access point and a Smart Edge device, which may increase customer cost. Moreover, when access points use a 1,500 B MTU, increasing the path MTU will require increasing the MTU on all of the access points in a customer deployment. Once again, this may result in a need for additional resources and increased costs to the customer. Moreover, some legacy switches/routers in a customer network may not even support an increase in the MTU. Thus, the recommendation from the RFC may not be feasible in many customer deployments.

### SUMMARY

In a first group of embodiments, an electronic device (such as an access point) that selectively fragments a packet is described. This electronic device includes an interface circuit that communicates with a second electronic device, where the electronic device and the second electronic device are tunnel endpoints. During operation, the electronic device receives a packet (e.g., from user equipment or a client) having a payload size. When the payload size exceeds a predefined value, the electronic device fragments the packet into two or more fragments, where a given fragment has a payload size that is less than the predefined value. Then, the electronic device encapsulates the two or more fragments using VxLAN tunnel encapsulation, where the VxLAN tunnel encapsulation adds VxLAN tunnel headers to the two or more fragments. Next, the electronic device provides, addressed to the second electronic device, the two or more tunnel encapsulated fragments.

Note that the packet may be an IP packet (which is sometimes referred to as an ‘inner packet’). When the IP packet has a do not fragment (DF) bit set in an IP header and the IP packet has a payload size larger than the predefined value, the electronic device may provide, addressed to the user equipment, an Internet Control Message Protocol (ICMP) fragmentation needed packet with a next hop MTU of the predefined value (e.g., 1450 B). Then, the electronic device drops the IP packet. Moreover, when forced fragmentation is enabled, and the IP packet has a DF bit set and has a payload size greater than the predefined value, the electronic device may clear the DF bit in the IP packet prior to fragmenting the packet into the two or more fragments.

Furthermore, the predefined value may be 1,450 B.

Additionally, the given fragment may include an IP fragment.

Note that a maximum payload size of a tunnel encapsulated fragment in the two or more tunnel encapsulated fragments may be 1,500 B.

In some embodiments, the fragmentation of the packet may prevent fragmentation of the two or more tunnel encapsulated fragments (which are sometimes referred to as ‘outer packets’).

Moreover, the user equipment may have a different MTU than the electronic device.

Another embodiment provides the second electronic device. When the second electronic device receives two or more tunnel encapsulated fragments, the second electronic device may de-encapsulate the two or more tunnel encapsulated fragments to create two or more fragments of a packet, where the de-encapsulation of a given tunnel encapsulated fragment removes the VxLAN tunnel header from the given tunnel encapsulated fragment. Then, the second electronic device forwards the two or more fragments to a destination (such as second user equipment or a second client). Note that the destination may reassemble the two or more fragments into the packet based at least in part on an IPv4 protocol.

Another embodiment provides a computer-readable storage medium with program instructions for use with the electronic device, the second electronic device or the user equipment. When executed by the electronic device, the second electronic device or the user equipment, the program instructions cause the electronic device, the second electronic device or the user equipment to perform at least some of the aforementioned operations or counterparts to at least some of the aforementioned operations in one or more of the preceding embodiments.

Another embodiment provides a method, which may be performed by the electronic device, the second electronic device or the user equipment. This method includes at least some of the aforementioned operations or counterparts to at least some of the aforementioned operations in one or more of the preceding embodiments.

In a second group of embodiments, an electronic device (such as an access point) performs path MTU discovery in a network to discover a smallest underlay path MTU along a network path between the electronic device and a second electronic device. Then, the electronic device to derives an overlay MTU based at least in part on the smallest underlay path MTU.

Another embodiment provides the second electronic device.

Another embodiment provides a computer-readable storage medium with program instructions for use with the electronic device or the second electronic device. When executed by the electronic device or the second electronic device, the program instructions cause the electronic device or the second electronic device to perform at least some of the aforementioned operations or counterparts to at least some of the aforementioned operations in one or more of the preceding embodiments.

Another embodiment provides a method, which may be performed by the electronic device or the second electronic device. This method includes at least some of the aforementioned operations or counterparts to at least some of the aforementioned operations in one or more of the preceding embodiments.

In a third group of embodiments, an electronic device (such as an access point) provisions a VxLAN tunnel between the electronic device and a second electronic device.

Another embodiment provides the second electronic device.

Another embodiment provides a computer-readable storage medium with program instructions for use with the electronic device or the second electronic device. When executed by the electronic device or the second electronic device, the program instructions cause the electronic device or the second electronic device to perform at least some of the aforementioned operations or counterparts to at least some of the aforementioned operations in one or more of the preceding embodiments.

Another embodiment provides a method, which may be performed by the electronic device or the second electronic device. This method includes at least some of the aforementioned operations or counterparts to at least some of the aforementioned operations in one or more of the preceding embodiments.

In a fourth group of embodiments, an electronic device (such as an access point) is provisioned to support multiple virtual network interfaces (VNI).

Another embodiment provides a computer-readable storage medium with program instructions for use with the electronic device. When executed by the electronic device, the program instructions cause the electronic device to perform at least some of the aforementioned operations or counterparts to at least some of the aforementioned operations in one or more of the preceding embodiments.

Another embodiment provides a method, which may be performed by the electronic device. This method includes at least some of the aforementioned operations or counterparts to at least some of the aforementioned operations in one or more of the preceding embodiments.

This Summary is provided for purposes of illustrating some exemplary embodiments to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for selectively fragmenting a packet in accordance with an embodiment of the present disclosure.

FIG. 3 is a flow diagram illustrating an example of a method for receiving two or more tunnel encapsulated fragments in accordance with an embodiment of the present disclosure.

FIG. 4 is a drawing illustrating an example of communication between an electronic device and a second electronic device in FIG. 1 in accordance with an embodiment of the present disclosure.

FIG. 5 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device (such as an access point) that selectively fragments a packet is described. This electronic device includes an interface circuit that communicates with a second electronic device, where the electronic device and the second electronic device are tunnel endpoints. During operation, the electronic device may receive a packet (e.g., from user equipment or a client) having a payload size. When the payload size exceeds a predefined value, the electronic device may fragment the packet into two or more fragments, where a given fragment has a payload size that is less than the predefined value. Then, the electronic device may encapsulate the two or more fragments using VxLAN tunnel encapsulation, where the VxLAN tunnel encapsulation adds VxLAN tunnel headers to the two or more fragments. Next, the electronic device may provide, addressed to the second electronic device, the two or more tunnel encapsulated fragments.

By fragmenting the packet, these communication techniques prevent a need for the packet to be fragmented after VxLAN tunnel encapsulation. Consequently, the communication techniques may maintain the throughput of the tunnel. Moreover, by fragmenting the packet, the communication techniques may eliminate a need to increase the MTU of the electronic devices along the tunnel, thereby eliminating the cost and/or complexity associated with such an upgrade. Thus, this capability may improve network performance (such as the performance associated with the VxLAN tunnel) using existing equipment (such as existing access points) and, therefore, may improve the user experience.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth or Bluetooth low energy (BLE), an IEEE 802.15.4 standard (which is sometimes referred to as Zigbee), a low-power wide-area network (LoRaWAN), a cellular-telephone network or data network communication protocol (such as a third generation or 3G communication protocol, a fourth generation or 4G communication protocol, e.g., Long Term Evolution or LTE or 5GC (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. More generally, the disclosed communication techniques may be compatible with one or more Wi-Fi Alliance generations, such as Wi-Fi 5, Wi-Fi 6, Wi-Fi 7 or a future Wi-Fi Alliance generation. Moreover, an access point, a radio node, a base station or a switch in the wireless network and/or the cellular-telephone network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

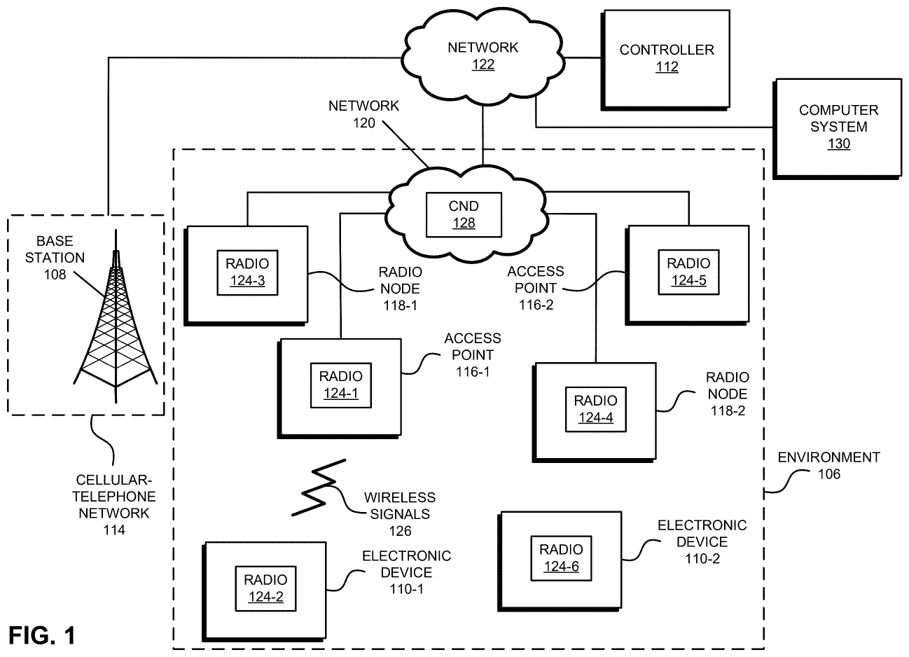

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a macrocell in a cellular-telephone network 114 (which may include a base station 108), one or more access points 116 (which may communicate using Wi-Fi) in a WLAN and/or one or more radio nodes 118 (which may communicate using LTE) in another cellular-telephone network (such as a small-scale network or a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘computer network device.’ Moreover, one or more base stations (such as base station 108), access points 116, and/or radio nodes 118 may be included in one or more wireless networks, such as: a WLAN and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or controller 112 (which may be a local or a cloud-based controller that manages and/or configures access points 116, radio nodes 118 and/or a computer network device (CND) 128, or that provides cloud-based storage and/or analytical services) using a wired communication protocol (such as Ethernet) via network 120 and/or 122. Alternatively, or additionally, access points 116 and/or radio nodes 118 may communicate with computer system 130 (which may include one or more computers at one or more locations) using the wired communication protocol. However, in some embodiments, access points 116 and/or radio nodes 118 may communicate with each other, controller 112 and/or computer system 130 using wireless communication (e.g., one of access points 116 may be a mesh access point in a mesh network). Note that networks 120 and 122 may be the same or different networks. For example, networks 120 and/or 122 may an LAN, an intra-net or the Internet. In some embodiments, network 120 may include one or more routers and/or switches (such as computer network device 128).

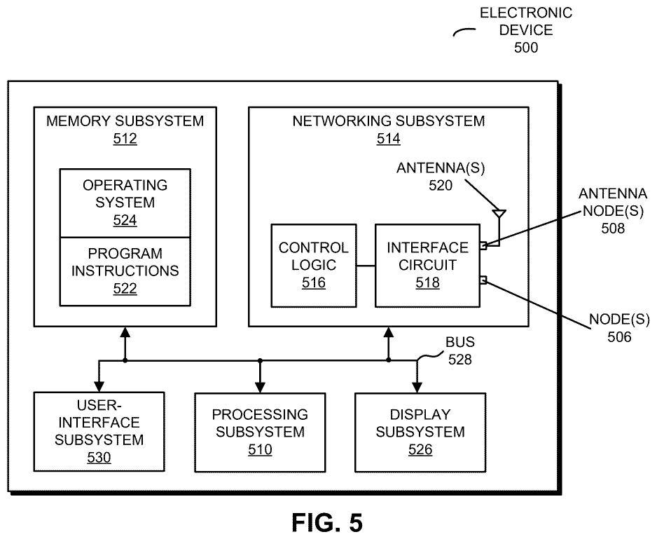

As described further below with reference to FIG. 5, electronic devices 110, controller 112, access points 116, radio nodes 118, computer network device 128, and/or computer system 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

As discussed previously, communicating a packet exceeding a predefined payload size (such as 1,450 B) in a VxLAN tunnel may necessitate fragmentation of a tunnel encapsulated packet (or an outer packet), which may degrade network performance (such as throughput) associated with the tunnel. In order to address this problem, in the discussed communication techniques an electronic device or tunnel endpoint (such as an access point, e.g., access point 116-1, or a Smart Edge device) may selectively fragment a packet. Access point 116-1 and a second electronic device or tunnel endpoint (such as another access point, e.g., access point 116-2, or a Smart Edge device) may securely communicate packets.

During operation, access point 116-1 may receive a packet (e.g., from user equipment or a client that is associated with access point 116-1, such as electronic device 110-1) having a payload size. When the payload size exceeds a predefined value, access point 116-1 may fragment the packet into two or more fragments (such as IP fragments), where a given fragment has a payload size that is less than the predefined value (e.g., 1,450 B). Note that the fragmentation may occur after the VLAN header(s) are added and, depending on the transport direction, the fragmentation may be performed by the nearest tunnel endpoint. Then, access point 116-1 may encapsulate the two or more fragments using VxLAN tunnel encapsulation, where the VxLAN tunnel encapsulation adds VxLAN tunnel headers to the two or more fragments. Next, access point 116-1 may provide, addressed to access point 116-2, the two or more tunnel encapsulated fragments or outer packets. In some embodiments, a maximum payload size of a tunnel encapsulated fragment in the two or more tunnel encapsulated fragments may be 1,500 B.

Note that the packet may be an IP packet or an inner packet. When the IP packet has a DF bit set in an IP header and the IP packet has a payload size larger than the predefined value, access point 116-1 may provide, addressed to electronic device 110-1, an ICMP fragmentation needed packet with a next hop MTU of the predefined value (e.g., 1450 B). Then, access point 116-1 may drops the IP packet. Moreover, when forced fragmentation is enabled, and the IP packet has a DF bit set and has a payload size greater than the predefined value, access point 116-1 may clear the DF bit in the IP packet prior to fragmenting the packet into the two or more fragments.

In some embodiments, the fragmentation of the packet may prevent fragmentation of the two or more tunnel encapsulated fragments.

Moreover, the user equipment may have a different MTU than the electronic device.

When access point 116-2 receives two or more tunnel encapsulated fragments, access point 116-2 may de-encapsulate the two or more tunnel encapsulated fragments to create two or more fragments of a packet, where the de-encapsulation of a given tunnel encapsulated fragment removes the VxLAN tunnel header from the given tunnel encapsulated fragment. Then, access point 116-2 may forward the two or more fragments to a destination (such as second user equipment or a second client of access point 116-2, e.g., electronic device 110-2). Note that the destination may reassemble the two or more fragments into the packet based at least in part on an IPv4 protocol.

In some embodiments, wireless communication between components in FIG. 1 uses one or more bands of frequencies, such as, but not limited to: 900 MHz, 2.4 GHz, 5 GHz, 6 GHz, 7 GHz, 8 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple input, multiple output (MIMO) communication.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

Note that, while FIG. 1 illustrates controller 112 and computer system 130 as separate components, in other embodiments these components may be combined into a single component. Thus, in some embodiments, computer system 130 may be a controller.

While the preceding embodiments illustrated the communication techniques with a constraint on the maximum payload size of the packet, in other embodiments the communication techniques may use a constraint on the maximum size of the packet. Moreover, while the preceding embodiments illustrated the communication techniques with a VxLAN tunnel, in other embodiments the communication techniques may be used with another type of tunnel.

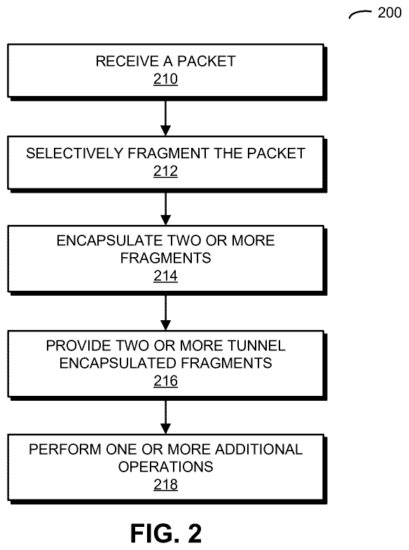

FIG. 2 presents an example of a method 200 for selectively fragmenting a packet, which may be performed by an electronic device (such as access point, e.g., access point 116-1, or a Smart Edge device). The electronic device and the second electronic device may be tunnel endpoints.

During operation, the electronic device may receive a packet (operation 210) (e.g., from user equipment or a client) having a payload size. When the payload size exceeds a predefined value, the electronic device may selectively fragment the packet (operation 212) into two or more fragments, where a given fragment has a payload size that is less than the predefined value. Then, the electronic device may encapsulate the two or more fragments (operation 214) using VxLAN tunnel encapsulation, where the VxLAN tunnel encapsulation adds VxLAN tunnel headers to the two or more fragments. Next, the electronic device may provide, addressed to the second electronic device, the two or more tunnel encapsulated fragments (operation 216).

Furthermore, the predefined value may be 1,450 B.

Additionally, the given fragment may include an IP fragment.

Note that a maximum payload size of a tunnel encapsulated fragment in the two or more tunnel encapsulated fragments may be 1,500 B.

In some embodiments, the fragmentation of the packet may prevent fragmentation of the two or more tunnel encapsulated fragments or outer packets.

Moreover, the user equipment may have a different MTU than the electronic device.

Furthermore, the packet may be an IP packet or an inner packet.

In some embodiments, the electronic device optionally performs one or more additional operations (operation 218). For example, when the IP packet has a DF bit set in an IP header and the IP packet has a payload size larger than the predefined value, the electronic device may provide, addressed to the user equipment or the client, an ICMP fragmentation needed packet (as indicated by a type field of ‘3’ for ‘destination unreachable’ and a code field of ‘4’ for ‘fragmentation needed and DF bit set’) with a next hop MTU equal to the predefined value. For example, the predefined value may be 1,450 B. Then, the electronic device may drop the IP packet. Moreover, when forced fragmentation is enabled, and the IP packet has a DF bit set and has a payload size greater than the predefined value, the electronic device may clear the DF bit in the IP packet prior to fragmenting the packet into the two or more fragments.

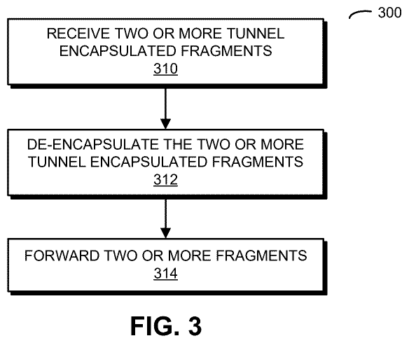

FIG. 3 presents an example of a method 300 for forwarding two or more fragments of a packet, which may be performed by a second electronic device (such as access point, e.g., access point 116-2, or a Smart Edge device). The electronic device and the second electronic device may be tunnel endpoints.

During operation, the second electronic device may receive two or more tunnel encapsulated fragments (operation 310). Then, the second electronic device may de-encapsulate the two or more tunnel encapsulated fragments (operation 312) to create the two or more fragments of the packet, where the de-encapsulation of a given tunnel encapsulated fragment removes the VxLAN tunnel header from the given tunnel encapsulated fragment. Next, the second electronic device may forward the two or more fragments (operation 314) to a destination (such as the user equipment or the client).

In some embodiments of methods 200 and/or 300, there may be additional or fewer operations. Furthermore, the order of the operations may be changed, and/or two or more operations may be combined into a single operation.

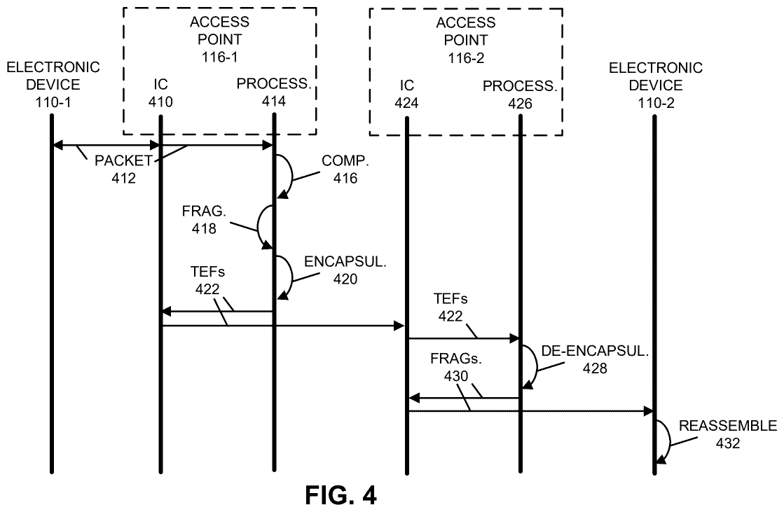

Embodiments of the communication techniques are further illustrated in FIG. 4, which presents a drawing illustrating an example of communication between access point 116-1 and access point 116-2.

During operation, an interface circuit (IC) 410 in access point 116-1 may receive a packet 412 (e.g., from a client that is associated with access point 116-1, such as electronic device 110-1) having a payload size. Then, interface circuit 410 may provide packet 412 to a processor 414 in access point 116-1. Processor 414 may compare 416 a payload size of packet 412 to a predefined value (such as 1,450 B). When the payload size exceeds the predefined value, processor 414 may fragment 418 packet 412 into two or more fragments, where a given fragment has a payload size that is less than the predefined value. Then, processor 414 may encapsulate 420 the two or more fragments using VxLAN tunnel encapsulation, where the VxLAN tunnel encapsulation adds VxLAN tunnel headers to the two or more fragments. Next, processor 414 may provide two or more tunnel encapsulated fragments (TEFs) 422 to interface circuit 410, which may provide, addressed to access point 116-2, the two or more tunnel encapsulated fragments 422.

An interface circuit 424 in access point 116-2 may receive the two or more tunnel encapsulated fragments 422. Then, interface circuit 424 may provide the two or more tunnel encapsulated fragments 422 to a processor 426 in access point 116-2. Processor 426 may de-encapsulate 428 the two or more tunnel encapsulated fragments 422 to create the two or more fragments 430 of packet 412, where de-encapsulation 428 of a given tunnel encapsulated fragment removes the VxLAN tunnel header from the given tunnel encapsulated fragment. Next, processor 426 may provide the two or more fragments 430 to interface circuit 424, which may forward, to a destination (e.g., to a client that is associated with access point 116-2, such as electronic device 116-2) the two or more fragments 430.

After receiving the two or more fragments 430, electronic device 116-2 may reassemble 432 the two or more fragments 430 into packet 412 based at least in part on an IPv4 protocol.

While FIG. 4 illustrates communication between components using unidirectional or bidirectional communication with lines having single arrows or double arrows, in general the communication in a given operation in this figure may involve unidirectional or bidirectional communication. Moreover, while FIG. 4 illustrates operations being performed sequentially or at different times, in other embodiments at least some of these operations may, at least in part, be performed concurrently or in parallel.

We now further describe the communication techniques. In a first group of embodiments, an electronic device (such as an access point or a Smart Edge device) selectively fragments a packet. These embodiments may avoid a need for changes to a customer network while still preventing outer-header fragmentation, thereby satisfying the restriction of non-fragmentation of outer headers put forth by the RFC. In these communication techniques, a tunnel endpoint (such as an access point or a Smart Edge device) may fragment an IP packet from user equipment (or an inner packet) before VxLAN tunnel encapsulation. The decision to fragment the inner packet may be done based at least in part on a payload size of the inner IP packet. That is, if the payload size of the inner IP packet is greater than 1,450 B, the inner packet may be fragmented into multiple fragments as needed, until the payload size of all of the fragments is less than or equal to 1,450 B. After this, the IP fragments may be encapsulated in VxLAN tunnel headers and forwarded to the other tunnel endpoint.

Note that the value 1,450 B is derived as 1,500 (a standard Ethernet MTU) minus 50 B (the VxLAN encapsulation overhead). This way, the maximum payload size of an encapsulated IP packet may be 1,500 B and thus, the network equipment between the tunnel endpoints will not need to ever fragment this encapsulated packet. The tunnel endpoint that receives this encapsulated packet may de-encapsulate the tunnel header and may forward the fragmented inner packet to the intended user equipment or destination without the need to reassemble the fragmented inner packets. The user equipment may receive the fragments and reassemble it as per the rules of IPv4 protocol.

Thus, without adding the additional overhead of reassembling the inner fragments (which otherwise would be bad for packet forwarding performance of the tunnel endpoint), the disclosed communication techniques may prevent outer header fragmentation, while retaining the path MTU of the network.

These communication techniques may also allow the user equipment to have its own IP MTU that could be higher than 1,500 B. This is not a deterrent to these communication techniques, as whatever be the payload size of the incoming packet from the client, the communication techniques may always use 1,450 B to fragment the incoming packet before encapsulation, thus preventing outer header fragmentation.

When the incoming IPv4 packets from user equipment has the DF bit set in the IP header (which may occur when the user equipment is performing Path MTU discovery or PMTUD), and the IP payload size is greater than 1,450 B, the tunnel end points may not fragment the packet. Instead, the tunnel endpoint may send a ‘ICMP fragmentation needed’ packet back to the user equipment and may drop the original packet with the DF bit set. In the ICMP fragmentation needed packet, the next hop MTU may be set to 1,450 B. This may allow the client to set its own MTU to 1,450 B.

Some legacy devices may perform PMTUD, but may fail to set next hop MTU as its own MTU. Consequently, communication between such a legacy device and the network will fail. To overcome this issue, the communication techniques may also support a feature called ‘Forced fragmentation,’ which may be disabled by default and can be enabled by the user/administrator as needed. When enabled, even if the incoming packet has a DF bit set, when the payload size of the IP packet is greater than 1,450 B, the tunnel endpoints may clear the DF bit in the original packet and may continue to fragment it as described previously. This may allow the user to overcome limitations associated with certain older/faulty user electronic devices.

In a second group of embodiments, an electronic device (such as an access point or a Smart Edge device) performs path MTU discovery in a network to discover a smallest underlay path MTU along a network path between the electronic device and a second electronic device. Then, the electronic device may derive an overlay MTU based at least in part on the smallest underlay path MTU.

Notably, a VxLAN tunnel protocol may add an additional overhead of 50 B as part of its tunnel encapsulation. Thus, for a user packet with IP payload size of 1,500 B (or an IP MTU of the user device of 1,500 B), the payload size of the encapsulated packet would be 1,550 B. In most deployments, the path MTU of the network would be 1,500 B (standard Ethernet MTU) and. thus, a VxLAN tunnel encapsulated packet may be fragmented to accommodate it within the 1,500 B MTU limit. The VxLAN RFC does not permit fragmentation of the outer packet (which is encapsulated with an IP header) and, thereby, recommends increasing the path MTU of the network to 1,550 B.

However, as described in the previous embodiments, the inner payload (in the user packet) may be fragmented to avoid outer fragmentation. This fragmentation may be performed by using 1,450 B as the VxLAN path MTU (an overlay network path MTU).

Note that he overlay path MTU is dependent on the underlay network path MTU (the underlay network may be the network traversed by the VxLAN tunnel encapsulated packets)

For example, when the underlay network path MTU is 1,500 B, then the overlay network MTU is 50 B less or 1,450 B. When the underlay path MTU is 1,200 B, then the overlay path MTU would be 1,150 B. In the underlay network between two tunnel endpoints, it is possible that different network devices (such as routers or switches) can have a different path MTU. Notably, when there are two routers between an access point and a Smart Edge device, then a first router can have a path MTU of 1,500 B and a second router can have a path MTU of 1,200 B. In such a case, the overlay MTU may be chosen such that it is 50 B less than the smallest underlay MTU in the network between the two tunnel endpoints. This is because, e.g., when the inner packet is fragmented using an overlay MTU of 1,450 B and the smallest MTU along the network path is 1,200 B, then the encapsulated packets will still be fragmented breaking the rule for fragmentation put forth by the RFC.

Consequently, the tunnel endpoints may need to discover the smallest underlay MTU and set the overlay MTU to 50 B less than the discovered underlay MTU. However, the VxLAN RFC does provide a method for path MTU discovery to arrive at the overlay MTU. In these embodiments, the access point may perform a path MTU discovery procedure of the underlay network as per provisions of RFC 1191 to discover the smallest underlay path MTU along the network path between the tunnel endpoints, such as the access point and the Smart Edge device. Then, the access point may use this information to derive the overlay MTU. The access point may send ICMP packets with the DF bit set to the IP address of the Smart Edge device, where size of the IP payload may be chosen to be between 68 B and the Wide Area Network (WAN) MTU of the access point (usually 1,500 B). The access point may use a binary search technique to choose a payload size between 68 and the WAN MTU of the access point, and may send an ICMP request of that payload size to the Smart Edge device.

When a response is received, the access point may try the next higher payload size as per the binary search technique by sending another ICMP request with the new payload size. Moreover, when a response is not received (which means the packet could not be forwarded because a lower path MTU somewhere along the network), the access point may try the next lower payload size as per the binary search technique by sending another ICMP request with the new payload size. This process may repeat until the binary search technique does not converge. When the binary search technique converges, the access point may have discovered the smallest underlay MTU that received an ICMP response from the Smart Edge device. Then, the access point may set the overlay MTU to be 50 B less than this discovered underlay MTU.

During the run of the aforementioned technique, for an ICMP request of a particular payload size, it is possible that an intermediate router/switch sends an ‘ICMP unreachable, fragmentation needed’ frame or packet back to the access point, because the DF bit was set. In such cases, a lower MTU value may be tried between 68 B and the next hop MTU value reported in the ICMP fragmentation frame or packet. The lower MTU may be chosen using a binary search technique. This process may be repeated when a newly tried lower MTU also elicits an ICMP unreachable, fragmentation needed packet.

Once the access point converges on the lowest path MTU for the underlay network, and derives the overlay MTU, the access point may report this MTU to the other tunnel endpoint, such as a Smart Edge device. The technique of reporting can be performed by use of communication protocols, such as NATS (from Synadia Communications, Inc. of San Mateo, California). This may prevent the Smart Edge device from doing the same discovery process, although it can initiate its own discovery process using the disclosed communication techniques. Specifically for the Transmission Control Protocol (TCP), both of the tunnel endpoints can modify the TCP Maximum Segment Size (MSS) option in the TCP packets from user electronic devices during the TCP handshake to set the discovered overlay MTU before VxLAN tunnel encapsulation.

This may ensure that the user electronic device does not have to initiate its own PMTUD to prevent its packets from being fragmented. Moreover, this may ensure that the user electronic device can restrict its packet or payload size to the VxLAN overlay MTU without knowing that its packets would be tunneled inside the VxLAN tunnel protocol.

Note that the number of ICMP requests sent and the time to wait for a response and other timeouts of the communication techniques may be configured to meet user needs. The communication techniques may be repeated periodically to adapt to changing path MTU along the underlay network. In subsequent runs, when an overlay MTU is already available, then the access point may first try to confirm that the current overlay MTU is still valid by sending an ICMP request with the relevant payload size. When the access point receives a response, it may try a higher MTU payload size between the current overlay MTU plus 50B and the WAN port MTU of the access point. Otherwise, the access point may try the lower payload size between the range 68 B and the current overlay MTU plus 50 B). This may be done for faster convergence of the process.

In some embodiments, the access point may also periodically report the current overlay MTU to the Smart Edge device, even when there is no change to the previously reported value to counter report packet drops along the network.

In a third group of embodiments, an electronic device (such as an access point) provisions a VxLAN tunnel between the electronic device and a second electronic device. Notably, the communication techniques may be implemented by a data path software/appliance (such as a Smart Edge device, a virtual data plane or vDP, etc.), network equipment (such as an access point, a switch, etc.), and/or an analytics service (which may be implemented using computer system 130 in FIG. 1).

In static provisioning of a VxLAN tunnel on a Smart Edge device, the tunnel may need to be established before a data packet arrives with the VNI identifier and the source. However, with a large number of access points, it may take too long to create the VxLAN tunnel(s).

During static provisioning technique (which is sometimes referred to as ‘static VxLAN tunnel creation’), an Advanced Client Experience (ACX) device (which is sometimes referred to as ‘RuckusOne’ from CommScope, Inc. of Claremont, North Carolina) may send a whitelist containing access point/switch IP and VNI to a Smart Edge device after onboarding. The Smart Edge device may create VxLAN interfaces per {access point/switch IP, VNI} or per {VNI} depending on the host operating system software requirements. This may occur before user equipment connects to the network and sends VxLAN tunnel encapsulated packets. This may result in a seamless usage experience to users.

These communication techniques may be an improvement over the currently used dynamic VxLAN tunnel creation, where a Smart Edge device may have to wait until packet(s) from user devices arrive and then the tunnel interfaces are created at runtime, which is typically not good for packet performance.

Moreover, regarding security, in the data path, when a Smart Edge device receives a VxLAN tunnel encapsulated packet whose source IP is not in the whitelist, the packet may be dropped. Furthermore, the packet may be reported to the analytics service for this incident, which may take appropriate actions, such as: incident reporting, user recommendations and/or automatic actions (such as a remedial action). This approach may be applicable to both static and dynamic provisioning techniques.

Furthermore, regarding optimization, during static provisioning, when a user provides information such as the range of VNIs to use and/or a number of personal area networks (PANs) to support and/or the PANs per site, then the Smart Edge device can statically provision VxLAN tunnel interfaces only for the configured/required set of VNIs (instead of all of the supported VNIs). Additionally, during static and dynamic provisioning, the analytics service can provide insights on access point-to-VNI correlation over time. This may help the Smart Edge device to remove unnecessary VxLAN interfaces and to only keep the active ones. This may useful when certain premises use specific VNI ranges and only those PANs need to be supported with those access points.

In a fourth group of embodiments, an electronic device (such as an access point) is provisioned to support multiple VNIs. Linux provides an implementation of a VxLAN protocol (a VxLAN driver) that usually supports only one VNI per VxLAN interface. In order to support multiple VNIs, Linux supports adding multiple VxLAN interfaces, one per VNI. From Linux kernel version 4.11 onward, a code patch provides a technique (called ‘VLAN tunnel’) that supports multiple VNIs on a single interface by providing a VLAN-to-VNI mapping. However, for an access point product, there are a couple of drawbacks with the above general support. Notably, adding multiple interfaces, one per VNI, consumes memory and often becomes difficult in terms of maintainability, especially because an access point product usually has less memory compared to a larger desktop machine or a server. This may make it difficult to scale to multiple interfaces. Moreover, because the interface per VNI needs to be added before the clients connect, there is a requirement that the VNI assigned per client must be known prior. This is not always feasible for an access point product. In particular, depending on the number of clients supported on the access point product, it may not make sense to add so many new interfaces, because each client may get a different VNI assigned and, in the worst case, hundreds of interfaces may need to be added. b.

For the VLAN-to-VNI mapping, although this avoids adding multiple interfaces, it necessitates that VLANs be assigned to clients and also define a mapping to a VNI. This may be possible with many customer deployments, because VLAN and VNI serve the same purpose from a broadcast domain point of view and a customer may prefer to assign different VNIs to different clients. Assigning different VNIs to different clients also gives flexibility to the customer to restrict broadcast domains of their clients better than a VLAN network, because only 4,096 (2¹²) VLANs may be assigned, whereas there may be 16 million or more VNIs (2²⁴). However, using this approach may force the customer to support both VLAN and VxLAN networks.

The disclosed communication techniques may overcome this limitation with additional custom implementation for storing VNIs for user electronic devices connected to an access point (such as an access point from particular manufacture(s)). Notably, a custom implementation VxLAN protocol may be coded in a Linux kernel, which performs the VxLAN functions as per the RFC. This driver may add a single VxLAN interface on the access point.

Additionally, a user device database/table (implemented as hash tables) may be maintained. When a user electronic device connects to the access point, an entry may be added to this table. This entry may represent a cache of details about the user electronic device. One of the details stored in this entry may be the VNI assigned to the user electronic device.

When a packet from a user electronic device is received in the custom VxLAN driver, a lookup may be performed into the table to fetch the details of the user electronic device. One of the fetched details may be the VNI, which can be used in the process of VxLAN tunnel encapsulation of the incoming packets from the user electronic device. For example, a driver for the VxLAN interface may encapsulate the VNI in a packet. This approach of storing VNI in a user electronic device table may be useful for two other purposes (apart from the preceding one) on the access point product.

Notably, for user electronic devices connected to the same access point, and having the same VNI (and thus the same broadcast domain), the access point may be able to switch them locally instead of sending them over the tunnel. By storing the VNIs per user electronic device in the table, this becomes possible. In a topology where the custom VxLAN interface is bridged (e.g., it is attached to a bridge), the access point may assign a first VLAN to all the user electronic devices (this may be mandatory, because a Linux bridge may understand only the VLAN and not the VNI) making them part of the same broadcast domain. But from a VNI point of view, they may be on different broadcast domains. Thus, the custom VxLAN interface may decide which user electronic device to forward to by looking up the VNI of the destination electronic device from the user table.

This may allow the access point to switch packets locally based at least in part on the VNI. After VxLAN de-encapsulation of a downstream packet (going towards a user electronic device), the VNI information in the VxLAN header may be lost. This is often a problem for wireless electronic devices, because the wireless protocol driver needs to know the VNI information to choose the right Group Temporal Key (GTK) to encrypt the broadcast/multicast traffic. The VNI and the GTK usually have a one-to-one relationship. Thus, a user electronic device lookup to get the VNI may be useful here.

In summary, storing a per user electronic device VNI in a user electronic device table may help access points support different use cases of VxLANs seamlessly without the limitations described previously. A single VxLAN interface may support multiple VNIs and may also support locally switch packets based at least in part on VNIs.

We now describe embodiments of an electronic device, which may perform at least some of the operations in the communication techniques. FIG. 5 presents a block diagram illustrating an example of an electronic device 500 in accordance with some embodiments, such as one of: base station 108, one of electronic devices 110, controller 112, one of access points 116, one of radio nodes 118, or computer system 130. This electronic device includes processing subsystem 510, memory subsystem 512, and networking subsystem 514. Processing subsystem 510 includes one or more devices configured to perform computational operations. For example, processing subsystem 510 can include one or more microprocessors, graphics processing units (GPUs), ASICs, microcontrollers, programmable-logic devices, and/or one or more digital signal processors (DSPs).

Memory subsystem 512 includes one or more devices for storing data and/or instructions for processing subsystem 510 and networking subsystem 514. For example, memory subsystem 512 can include DRAM, static random access memory (SRAM), and/or other types of memory. In some embodiments, instructions for processing subsystem 510 in memory subsystem 512 include: one or more program modules or sets of instructions (such as program instructions 522 or operating system 524, such as Linux, UNIX, Windows Server, or another customized and proprietary operating system), which may be executed by processing subsystem 510. Note that the one or more computer programs, program modules or instructions may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments electronic device 500 includes one or more nodes, such as antenna nodes 508, e.g., a metal pad or a connector, which can be coupled to the one or more antennas 520, or nodes 506, which can be coupled to a wired or optical connection or link. Thus, electronic device 500 may or may not include the one or more antennas 520. Note that the one or more nodes 506 and/or antenna nodes 508 may constitute input(s) to and/or output(s) from electronic device 500.) For example, networking subsystem 514 can include a Bluetooth networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 500 may be adapted or changed using pattern shapers (such as directors or reflectors) and/or one or more antennas 520 (or antenna elements), which can be independently and selectively electrically coupled to ground to steer the transmit antenna pattern in different directions. Thus, if one or more antennas 520 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 500 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting advertising or beacon frames and/or scanning for advertising frames transmitted by other electronic devices as described previously.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Moreover, electronic device 500 may include a user-interface subsystem 530, such as: a mouse, a keyboard, a trackpad, a stylus, a voice-recognition interface, and/or another human-machine interface. In some embodiments, user-interface subsystem 530 may include or may interact with a touch-sensitive display in display subsystem 526.

Electronic device 500 can be (or can be included in) any electronic device with at least one network interface. For example, electronic device 500 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. Also, although separate subsystems are shown in FIG. 5, in some embodiments some or all of a given subsystem or component can be integrated into one or more of the other subsystems or component(s) in electronic device 500. For example, in some embodiments instructions 522 is included in operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 514 and/or of electronic device 500. The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape, an optical, a magnetic disk or a solid-state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 522, operating system 524 (such as a driver for interface circuit 518) or in firmware in interface circuit 518. Alternatively, or additionally, at least some of the operations in the communication techniques may be implemented in a physical layer, such as hardware in interface circuit 518.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a second electronic device, wherein the electronic device and the second electronic device are tunnel endpoints, and wherein the electronic device is configured to:
receive a packet having a payload size;
when the payload size exceeds a predefined value, fragment the packet into two or more fragments, wherein a given fragment has a payload size that is less than the predefined
value;
encapsulate the two or more fragments using Virtual eXtensible Local-Area Network (VxLAN) tunnel encapsulation, wherein the VxLAN tunnel encapsulation adds VxLAN tunnel headers to the two or more fragments; and
provide, addressed to the second electronic device, the two or more tunnel encapsulated fragments.

2. The electronic device of claim 1, wherein the electronic device comprises an access point.

3. The electronic device of claim 1, wherein the packet is received from a client that is associated with the electronic device.

4. The electronic device of claim 1, wherein the packet comprises an Internet Protocol (IP) packet.

5. The electronic device of claim 4, wherein, when the IP packet has a do not fragment (DF) bit set in an IP header and the IP packet has a payload size larger than the predefined value, the electronic device is configured to:
provide, addressed to a client that is associated with the electronic device, an Internet Control Message Protocol (ICMP) fragmentation needed packet with a next hop maximum transmission unit (MTU) equal to the predefined value; and
drop the IP packet.

6. The electronic device of claim 4, wherein, when forced fragmentation is enabled, and the IP packet has a do not fragment (DF) bit set and is greater than the predefined value, the electronic device is configured to clear the DF bit in the IP packet prior to fragmenting the packet into the two or more fragments.

7. The electronic device of claim 1, wherein the predefined value is 1,450 B.

8. The electronic device of claim 1, wherein the given fragment comprises an Internet Protocol (IP) fragment.

9. The electronic device of claim 1, wherein a maximum payload size of a tunnel encapsulated fragment in the two or more tunnel encapsulated fragments is 1,500 B.

10. The electronic device of claim 1, wherein the fragmentation of the packet prevents fragmentation of the two or more tunnel encapsulated fragments.

11. The electronic device of claim 1, wherein packet is received from a client associated with the electronic device, and the client has a different maximum transmission unit (MTU) than the electronic device.

12. A method for selectively fragmenting a packet, comprising:
by an electronic device, wherein the electronic device and a second electronic device are tunnel endpoints:
receiving a packet having a payload size;
when the payload size exceeds a predefined value, fragmenting the packet into two or more fragments, wherein a given fragment has a payload size that is less than the predefined value;
encapsulating the two or more fragments using Virtual eXtensible Local-Area Network (VxLAN) tunnel encapsulation, wherein the VxLAN tunnel encapsulation adds VxLAN tunnel headers to the two or more fragments; and
providing, addressed to the second electronic device, the two or more tunnel encapsulated fragments.

13. The method of claim 12, wherein the electronic device comprises an access point.

14. The method of claim 12, wherein, when the packet comprises an Internet Protocol (IP) packet, the IP packet has a do not fragment (DF) bit set in an IP header and the IP packet has a payload size larger than the predefined value, the method comprises:
providing, addressed to a client that is associated with the electronic device, an Internet Control Message Protocol (ICMP) fragmentation needed packet with a next hop maximum transmission unit (MTU) equal to the predefined value; and
dropping the IP packet.

15. A second electronic device, comprising:
an interface circuit configured to communicate with an electronic device, wherein the electronic device and the second electronic device are tunnel endpoints, and wherein the second electronic device is configured to:
receives two or more tunnel encapsulated fragments;
de-encapsulate the two or more tunnel encapsulated fragments to create two or more fragments of a packet, wherein the de-encapsulation of a given tunnel encapsulated fragment removes a Virtual eXtensible Local-Area Network (VxLAN) tunnel header from the given tunnel encapsulated fragment; and
forward the two or more fragments to a destination.

16. The second electronic device of claim 15, wherein the electronic device comprises an access point.

17. The second electronic device of claim 15, wherein the destination comprises a client that is associated with the electronic device.

18. The second electronic device of claim 15, wherein the packet comprises an Internet Protocol (IP) packet.

19. The second electronic device of claim 15, wherein a tunnel encapsulated fragment in the two or more tunnel encapsulated fragments comprises an Internet Protocol (IP) fragment.

20. The second electronic device of claim 15, wherein a maximum payload size of a tunnel encapsulated fragment in the two or more tunnel encapsulated fragments is 1,500 B.
